(19) United States
(12) Patent Application Publication
(10) Pub. No.: US 2007/0088550 A1
(43) Pub. Date: Apr. 19, 2007

(54) Method for predictive maintenance of a machine

(76) Inventors: Dimitar Filev, Novi, MI (US); Fling Tseng, Ann Arbor, MI (US); Gary Farquhar, Farmington Hills, MI (US); Dave Chesney, Northville, MI (US); Youssef Hamidieh, Bloomfield Hills, MI (US); Pundarikaksha Baruah, Detroit, MI (US); Ratna Babu Chinnam, Rochester, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 11/249,601

(22) Filed: Oct. 13, 2005

(51) Int. Cl. G10L 15/06

(52) U.S. Cl. 704/245

(57) ABSTRACT

A method for predictive maintenance of a machine includes collecting feature data for the machine which includes a plurality of feature vectors. At least some of the feature vectors are standardized to facilitate compatibility between different vectors. At least some of the standardized feature vectors are transformed into corresponding two-dimensional feature vectors. At least some of the two-dimensional feature vectors are clustered together based on operating modes of the machine. Similar steps are performed on additional feature data collected from the machine. Recently gathered two-dimensional feature vectors are compared to previously clustered feature vectors to provide predictive maintenance information for the machine.

### BACKGROUND OF THE INVENTION

1. Field of the Invention

The present invention relates to a method for predictive maintenance of a machine.

2. Background Art

Although there are a variety of systems and methods for monitoring and maintaining machinery and equipment, each has one or more inherent limitations which limit its usefulness. For example, many condition-monitoring algorithms operate by continuously comparing newly extracted features—i.e., machine conditions—to their corresponding baseline values. These baseline characteristics are essentially the statistical means of the features collected during the setup phase. The diagnostic capabilities of conventional predictive maintenance systems are based on applying different types of thresholds, templates, and rules, to quantify the relationship between the current feature values and their baseline counterparts.

One limitation of this type of system is that during the process of monitoring the machine features, the thresholds remain unchanged unless an expert interferes to force their recalculation. This type of human intervention. usually results from the observation of frequent false alarms caused by a process mean shift. Therefore, it would be desirable to have a method for predictive maintenance of a machine which utilizes unsupervised learning techniques, and which can identify a significant change in the pattern of monitored machine factures.

Another limitation of conventional machine monitoring methods and condition-based maintenance (CBM) technologies is that their application is limited to a particular machine. Over time, there may be extensive characterization of the physical and mechanistic principles that guide the equipment behavior and evolution. While this may lead to accurate information about a particular machine, such technologies are extremely limiting when it comes to widespread deployment for a wide variety of equipment. Therefore, it would be desirable to have a method for predictive maintenance of a machine, which developed a “generic” framework that was relatively independent of the type of physical equipment under consideration.

### SUMMARY OF THE INVENTION

At least one embodiment of the present invention provides a Predictive Maintenance (PdM) Agent which utilizes a generic prognostic novelty detection based learning algorithm that is not dependent on the specific measured parameters determining the health of the particular machine. The PdM Agent utilizes a combination of measured machine characteristics in the time and frequency domain, process parameters, energy levels, and other parameters that can describe the state of a piece of equipment. This set of measured variables, called the feature set, is standardized and mapped in real time to the space of principal components.

The first two principal components of the feature vector are monitored and visualized in the two-dimensional (2-D) space. A real time, unsupervised clustering algorithm is applied to identify stable patterns that constitute different operating modes of the equipment in order to minimize potential false positive alarms due to significant changes of the feature pattern. Two alternative strategies are used to recognize both abrupt and gradually developing (incipient) changes. The algorithm also predicts whether incipient changes may lead to significantly patterns, and subsequently to fault conditions.

Before generating a final decision for a potential fault warning, a comparison is made between the prediction in the multiple feature space and the statistical performance of those features that are expected to have a strong influence on the machine performance. The final determination of fault prediction may utilize visual tools to simplify the validation of the predictions made by the diagnostic/prognostic algorithm. The algorithm may be implemented as a set of recursive real time procedures that do not require storing a large amount of data. The algorithm can be realized as a stand alone event-driven software agent that is interfaced to a server storing raw machine data.

The input to the PdM Agent is a feature vector that characterizes the status of the equipment being monitored. The features may include time, frequency or energy characteristics, process parameters or other measured attributes. Some features which may used by the PdM Agent for machine health monitoring of rotating equipment include time domain features such as time domain data statistics and auto regressive (AR) model parameters. Time domain features can be calculated directly from raw vibration signals picked up by one or more sensors attached to the machine being monitored. Time domain data statistics include such things as root mean square (RMS), crest factor, variance, skewness, and kurtosis. Auto regressive model parameters may use the Burg method to fit a predefined order (p) of an AR model to the input signals by minimizing the forward and backward prediction errors, while constraining the AR parameters to satisfy the Levinson-Durbin recursion.

Other types of features which may be used with the PdM Agent include frequency domain features, which may use a transform such as a Fast Fourier Transform (FFT) to transform time-based vibration signals into a frequency domain. The PdM Agent may also use energy features, where energy bands are calculated from derived frequency blocks. A velocity amplitude spectrum is another feature which may be utilized by the PdM Agent. Utilizing the data obtained after applying an FFT, a velocity amplitude spectrum can be estimated. Of course, energy, frequency and velocity spectrum features can be obtained directly from frequency signatures without performing an FFT from time waveform signals. Moreover, the PdM Agent is not limited to receiving vibration data, but rather, it could receive data from temperature sensors, velocity sensors, or other instruments, which monitor the machine characteristics.

The prediction model of the PdM Agent includes two hierarchal levels of evolving clusters that are dynamically populated and updated as new features are gathered. Operating Mode (OM) clusters represent different prototypical modes of operation of monitored machines. Operating Conditions (OC) clusters cover alternative operating conditions within individual operating modes. The OM clusters are associated with significantly different, but repetitive, machine signatures—e.g., start-up, normal or idle operating modes. Although the machine may switch from one mode to another mode, it is anticipated that the machine will remain at least for a short time within one of these modes. During this time the expectation is that similar patterns will be seen, which might be slightly different, but remain within the same envelope of operating conditions.

When the PdM Agent is being setup, it is not expected that all possible OM clusters will be seen. Rather, it is expected that the OM clusters will evolve over time in order to identify new operating modes that have not been initially observed. The evolution of the OM clusters provides a process of creation of new clusters, and a process of continuous updating of the existing OM clusters. The former accounts for potential new operating modes, outliers, drastic faults, or some combination thereof. The latter represents the gradual changes in machine characteristics. Drastic faults are viewed as potentially new operating modes because they exemplify dramatically new patterns that have not been previously observed. Two differences between a drastic fault and an actual operating mode are: 1) that a drastic fault is unstable, and 2) that a drastic fault includes fewer feature vectors than the normal operating modes. Therefore, the number of feature vectors in an OM cluster, and the extensive creation of new OM clusters, can be used to diagnose a drastic fault as opposed to a new operating mode.

The OC clusters are singles or groups of clusters that are included within the OM clusters. They exemplify changing operating conditions within an operating mode. The root cause for the evolution of the OC clusters can be changes of machine parameters, or gradual wear-off conditions. New operating conditions can be created over time because they may not necessarily be completely identified during the setup. Their evolution is driven by gradual modification of the cluster parameters or by creation of new clusters. The trend of changing the OC clusters is used to predict a potential incipient fault.

Another aspect of using the OM clusters, is that their relative stability and repetitive feature patterns allow them to be used to define local mappings between the K-dimensional (K-D) feature space and the two-dimensional space of the first two principal components (PC's). Use of the K-D to 2-D transformation reduces dimensionality of the feature space, decreases the amount of insignificant information, and allows for visualization of the decision making process. The covariance matrices associated with each of the OM clusters are used to update the mappings transforming the features in the OM clusters to their 2-D images in the co-domain space of the first two PC's. Therefore, each of the OM clusters in the feature space has a 2-D counterpart that includes multiple evolving 2-D OC clusters.

Another embodiment of the present invention provides a diagnostics and prognostics framework (DPF) that is relatively independent of the type of physical equipment under consideration. Much of the modeling and estimation procedures employed by the DPF are based on unsupervised learning methods, which reduce the need for human intervention. The procedures are also designed to temporally evolve parameters with monitoring experience for enhanced diagnostic/prognostic accuracy. The framework also makes a provision for incorporating end-user feedback for enhancing the diagnostic/prognostic accuracy.

The DPF employs a procedure to combine principal component analysis (PCA) based dimensionality reduction with an unsupervised clustering technique. Initially, a single principal component transformation matrix (called “raw basis”) is constructed from signal/feature data. As discussed above with regard to the PdM Agent, such signal/feature data may be gathered from one or more sensors monitoring the operating conditions of a particular machine. The DPF then uses a kernel density based unsupervised clustering technique to cluster the data in the space of the two most dominate PC's, to identify different equipment “modes of operation”. Data points from individual clusters or modes are then identified using sets of indices. A PC transformation matrix is then recomputed for each individual cluster or mode using the corresponding index set. This leads to a different mode basis for a distinct operating mode/cluster. The diagnostics engine employs these bases for raising pertinent alarms during future monitoring.

Given that equipment behavior evolves because of such processes as wear-in, maintenance, and wear-out, the DPF is configured to effectively track this non-stationary behavior. The DPF employs a cluster tracking procedure using an optimal exponential waiting scheme. In particular, it employs the following two strategies to enhance the performance of the diagnostics engine. First, the on-line determination of an optimal exponential discounting factor ensures that the cluster tracking is effective in matching the rate of evolution of the equipment operating mode behavior. Second, the DPF includes a provision to allow differing exponential discounting factors for different clusters to further enhance the performance of the diagnostics engine. The discounting factor is optimized based on an objective function that employs a generalized statistical distance (also called Mahalanobis distance) cost function in the dominant PC space.

The DPF may be viewed as being composed of four different processes. The first is automated dimensionality reduction, discussed above. The second is multivariate and univariate characterization of equipment evolutionary behavior. Multivariate adaptive clustering methods attempt to distinctly characterize naturally inherent different operating modes and behaviors. Conversely, the univariate signal/feature enveloping technique attempts to represent equipment evolutionary behavior by separately modeling each promising signal/feature. The third process is detection of anomalous behavior through the use of a diagnostics engine, and the fourth process includes a prognostics engine that estimates remaining useful life.

The present invention also provides a method for predictive maintenance of a machine, which includes collecting data related to operation of the machine. At least some of the data is transformed into feature vectors in a first feature space. At least some of the feature vectors are standardized, thereby creating standardized feature vectors in a standardized feature space. At least some of the standardized feature vectors are transformed into two-dimensional feature vectors in a two-dimensional feature space. At least some of the two-dimensional feature vectors are clustered, based on similarity between the two-dimensional feature vectors. This forms at least one two-dimensional vector cluster. Additional data related to operation of the machine is then collected. At least some of the additional data is transformed into additional feature vectors in the first feature space. At least some of the additional feature vectors are standardized, thereby creating additional standardized feature vectors in the standardized feature space. At least some of the additional standardized feature vectors are transformed into additional two-dimensional feature vectors in the two-dimensional feature space. At least some of the additional two-dimensional feature vectors are analyzed relative to the at least one two-dimensional vector cluster to provide predictive maintenance information for the machine.

The invention also provides a method for predictive maintenance of a machine, which includes collecting feature data for the machine while the machine is operating. The feature data includes a plurality of feature vectors. At least some of the feature vectors are standardized to facilitate compatibility between the standardized feature vectors. At least some of the standardized feature vectors are transformed into corresponding two-dimensional feature vectors. At least some of the two-dimensional feature vectors are clustered, based on operating modes of the machine, thereby forming a plurality of two-dimensional operating mode clusters. Additional feature data is collected while the machine operating. The additional feature data includes a plurality of additional feature vectors. At least some of the additional feature vectors are standardized, and at least some of the additional standardized feature vectors are transformed into corresponding additional two-dimensional feature vectors. An algorithm is applied to at least some of the additional two-dimensional feature vectors to facilitate a comparison between the operation of the machine when the feature data was collected and operation of the machine when the additional feature data was collected. This provides predictive maintenance information for the machine.

The invention further provides a method for predictive maintenance of a machine, which includes collecting feature data for the machine, defining feature vectors from the feature data, standardizing the feature vectors, and clustering the standardized feature vectors based on operating modes of the machine. The standardized feature vectors are transformed into corresponding two-dimensional feature vectors, which are then clustered at least based on the operating modes of the machine. The method also includes recursively analyzing new feature data relative to at least some of the clusters, thereby providing predictive maintenance information for the machine.

### BRIEF DESCRIPTION OF THE DRAWINGS

FIG. 1 is a flowchart illustrating a portion of a method of the present invention;

FIG. 2 is a schematic drawing illustrating the cluster-based structure of the method described in FIG. 1;

FIG. 3 is a flowchart illustrating another portion of the method described in FIG. 1;

FIG. 4 is a schematic drawing illustrating the cluster-based structure of the method described in FIG. 3;

FIG. 5 is a chart showing results of testing performed using a PdM Agent algorithm in accordance with the present invention, including a prediction of a Type 1 failure;

FIG. 6 is a chart showing results of testing performed using a PdM Agent algorithm in accordance with the present invention, including a prediction of a Type 2 failure; and

FIG. 7 is a flowchart illustrating another embodiment of a method in accordance with the present invention.

### DETAILED DESCRIPTION OF THE PREFERRED EMBODIMENT(S)

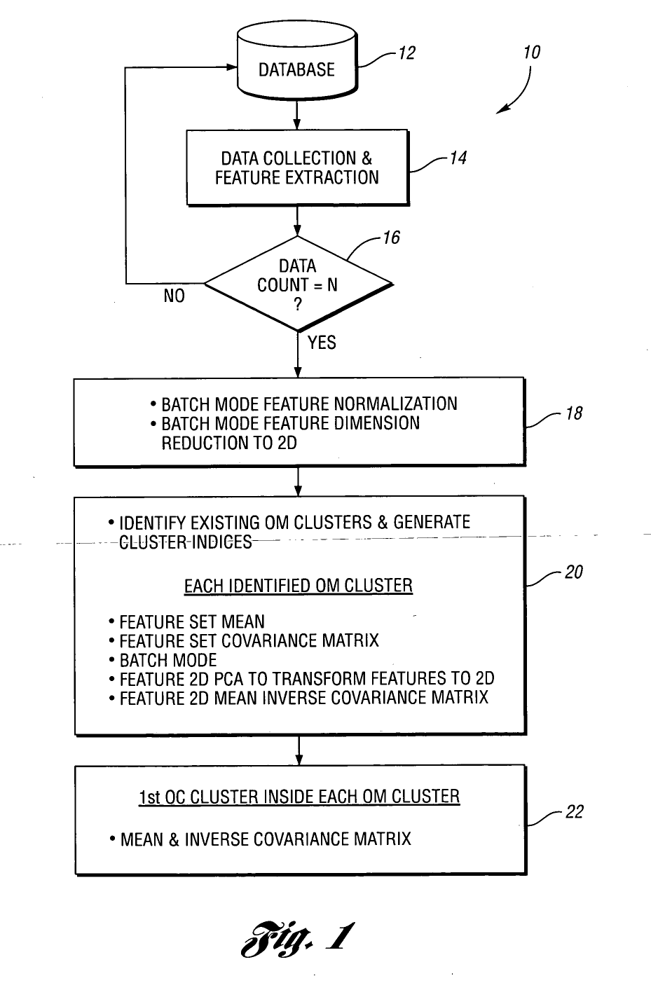

FIG. 1 shows a flow chart 10 illustrating a portion a method used by a PdM Agent in accordance with the present invention. There are two execution phases in the PdM Agent algorithm—an initialization phase and a monitoring phase. Both phases are based on unsupervised learning. The initialization phase, shown in FIG. 1, is optional; however, its execution can have a positive effect on the performance of the learning algorithms in the monitoring phase. During the initialization phase, initial operating modes are identified and their corresponding parameters are calculated in a batch mode. Once the initialization phase is performed, the PdM Agent enters a monitoring phase which is described below.

Both the initialization and monitoring phases are preceded by a feature extraction phase wherein a set of features is extracted from the time domain sensor signal. For example, a machine such as a fan, compressor, pump, etc. may have attached to it one or more sensors configured to monitor vibrations as the machine operates. To monitor the vibrations, one or more accelerometers or other vibration sensing devices could be used. It is worth noting that although the exemplary illustrations contained herein use vibrations to determine machine features, other types of machine data could be used. For example, a current sensor may be used to measure changes in the amount of current the machine draws during various operations. Similarly, a thermocouple, or other type of temperature sensor, could be used to detect changes in temperature of some portion of the machine. The machine speed or torque could also be sensed to provide data relating to the operation of the machine.

Depending on the type of sensor or sensors employed, the raw signal itself may be able to be used as a feature, and therefore, would need no feature extraction process. Alternatively, the raw signal may be used in a feature extraction scheme to put the data in the appropriate form. For example, as described above, extracted from vibration data for a rotating machine may be time domain features, frequency domain features, energy features, or a velocity amplitude spectrum. Transformation of raw data into a feature vector could include the application of a statistical equation, such as determining the root mean square (RMS) of the raw data, or applying a Fast Fourier Transform (FFT) to the data. The configuration of the feature set is done when the PdM Agent is configured. The result of the feature extraction phase is a K-dimensional feature vector.

During the initialization phase, the PdM Agent collects new data until a predefined number of feature vectors, N, for agent initialization is reached. The lower bound for (N) is estimated from the minimal number of independent parameters of the feature covariance matrix—i.e., the minimal number of steps is:
Nmin=K(K−1)/2.
where K is the dimension of the feature vector. When at least Nmin data readings are accumulated, the following tasks are conducted in sequence as shown in the flow chart 10 in FIG. 1.

The PdM Agent may reside in a one or more controllers which are part of larger information system used to gather and process information about equipment and processes in a manufacturing, or other, facility. In the embodiment shown in FIG. 1, the information system includes a database 12, which is used to store gathered data for access by the PdM Agent. At step 14, data is collected and features are extracted, for example, as described above. At step 16, it is determined whether the predefined number of feature vectors (N) is reached. If not, the process loops back to collect more data and extract more features. If the data count has reached (N), the process continues at step 18.

At step 18, feature normalization and dimension reduction occur; as shown in FIG. 1, these may be performed in batch mode. The feature normalization can be mathematically represented as follows. Assume that (N) observations are accumulated and Y^{R}(k) is a K-dimension raw feature vector. In order to ensure that all features are within same magnitude in their variations, independent of their different physical meanings, the feature vectors are standardized as follows:

$$\begin{matrix}Y ( k ) = ( {Y}_{i}^{R} ( k ) - {Y}_{i}^{*} ) / {σ}_{i} , i = [ 1 , K ] \\ where & ( 1 ) \\ {Y}^{*} = {\sum }_{k = 1}^{N} {Y}^{R} ( k ) / N & ( 2 ) \\ σ = {diag ( {\sum }_{k = 1}^{N} ( {Y}^{R} ( k ) - {Y}^{*} ) ( {Y}^{R} ( k ) - {Y}^{*} ) / N )}^{.05} & ( 3 )\end{matrix}$$

Y^{*} and σ are the vectors of the means and the standard deviation of individual features, and Y(k) is the standardized feature vector.

In order to reduce the dimension of the feature vectors, a Principal Component Transformation is applied to extract the first two principal components of the standardized feature vectors. This dimensional reduction also facilitates classification of the feature vectors in clusters corresponding to the main operating modes observed during the initialization phase. Performing a Singular Value Decomposition (SVD) on the covariance matrix (S) yields:
S=V*A*T (4)
The first two columns T⁽¹²⁾ of the transformation matrix T define a mapping from the standardized feature vector space to the 2-D PC space:
y(k)=Y(k)*T⁽¹²⁾ (5)
where y(k) is the standardized featured vector in the 2-D PC space.

At step 20, clustering occurs based on some similarity among the feature vectors, for example, based on operating modes of the machine. In such a case, Operating Mode (OM) clusters are identified, and OM cluster indices are generated. The standardized feature vectors may be clustered according to any criteria effective to facilitate diagnostics and/or prognostics on the machine being observed. Clustering according to an operating mode—such as startup and normal or idle operating modes—as illustrated in FIG. 1, may be particularly beneficial, however, in that different data may be expected from one operating mode to another, but similar data may be expected from the same operating mode occurring at different times. This allows for a comparison of data that can be used to help predict machine anomalies.

The process illustrated in step 20 identifies the unknown number of existing OM clusters and initializes each of the identified OM cluster parameters. To accomplish this, any of a number of algorithms could be applied. For example, a Greedy Expectation Maximization clustering algorithm can be applied to identify the number of clusters corresponding to different operating modes. The Greedy Expectation Maximization Algorithm may be based on incremental mixture density estimation, and can use a combination of a global and a local search each time a randomized new component is inserted to the mixture to obtain optimal mixtures.

Another algorithm that can be used is a Mounting Clustering algorithm. The Mounting Clustering algorithm is applied on the (N) transformed 2-D feature data points y(k), k=[1, N] that are obtained in Step 18. The result of the clustering algorithm is the number of OM clusters, m, the mean and covariance matrix y₍ⱼ₎^{*} and s₍ⱼ₎, and the vector of membership n₍ⱼ₎, j=[1, m], of the 2-D feature vectors y(k) with respect to each of the OM clusters. The membership vectors n₍ᵢ₎ are used to initialize the prototype OM clusters in the standardized feature space. Thus, for the OM clusters in the standardized feature space, the feature vectors Y₍ⱼ₎ belonging to each operating mode, and the mean and covariance matrix Y₍ⱼ₎^{*}, S₍ⱼ₎, are obtained.

Application of this algorithm facilitates a refining of the standardization by applying expressions (1)-(3) on each of the operating modes. One reason for performing the clustering in the PC space, {y(k), k=[1, N]}, rather than in the domain space, {Y(k), k=[1, N]}, is to visualize the result and to check the meaningfulness of the identified clusters. The Mounting Clustering algorithm is applied only during the initialization phase. In the following monitoring phase, allowance is made for the OM clusters to evolve and grow in number, reflecting potentially new operating modes. That is, with every new feature vector, the number of the OM clusters (m) and their means and covariance matrices Y₍ⱼ₎^{*}, S₍ⱼ₎, j=[1, m], are updated.

The transformation matrix T₍ⱼ₎⁽¹²⁾ of a particular operating mode with its unique basis defined by the first two PC components are then derived from the OM covariance matrices S₍ⱼ₎ according to expressions (4) and (5). The 2-D images y₍ⱼ₎ of the feature vectors of Y₍ⱼ₎ are obtained through a PC transformation with T₍ⱼ₎⁽¹²⁾ and expression (5). This is the principal component analysis (PCA) transformation shown in step 20. The mean and inverse covariance matrix, y₍ⱼ₎^{*} and s₍ⱼ₎⁻¹ belonging to each of the 2-D OM clusters, can be obtained directly from y₍ⱼ₎.

At step 22, Operating Condition (OC) clusters are formed, and the mean and covariance matrix is determined for each feature vector. The Operating Conditions used to form the additional clusters may be based on alternative operating conditions within an individual Operating Mode. Thus, if during the startup mode, there are different operating conditions which are detected through the data collection, then data related to a particular operating condition can be clustered into an OC cluster.

It is assumed that each operating mode starts with one operating condition which is characterized by its mean and inverse covariance matrix, y_{(j).OC(1)}^{*} and s_{(j).OC(1)}⁻¹, that are initially identical to the respective OM cluster parameters, i.e.:
y_{(j).OC(1)}^{*}=y₍ⱼ₎^{*} (6)
s_{(j).OC(1)}⁻¹=s₍ⱼ₎⁻¹
After all identified OM clusters are initialized, the following parameters are updated upon the arrival of new readings:
OM clusters: Y^{*}, S, y^{*} and s⁻¹
OC clusters: y_{OC}^{*} and s_{OC}^{*}

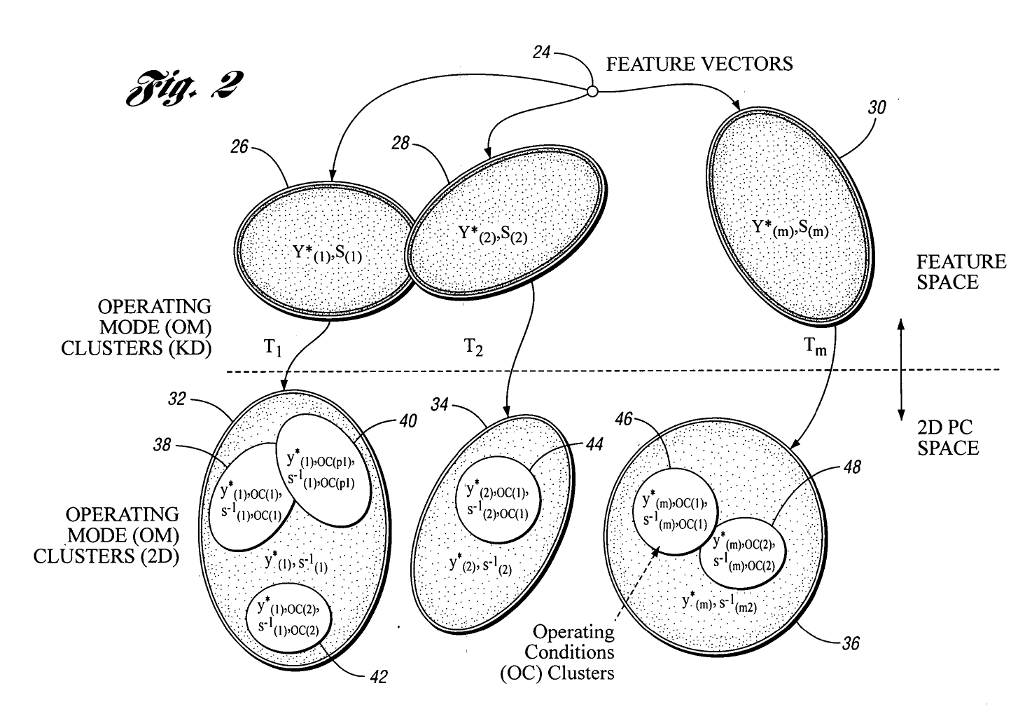

The steps described in FIG. 1 are schematically illustrated in FIG. 2. At the top of the diagram, the feature vectors 24 are standardized and grouped in OM clusters 26, 28, 30, with cluster 30 being the m^{th} cluster. The clusters 26, 28, 30 are in the feature space, which is a K-dimensional space. In the lower portion of FIG. 2, the standardized feature vectors are transformed into 2-D space, resulting in 2-D OM clusters 32, 34, 36, where cluster 36 is the m^{th} cluster. Within each of the 2-D OM clusters are OC clusters 38, 40, 42, 44, 46, 48. As shown in FIG. 2, not all of the OM clusters necessarily have the same number of OC clusters within them.

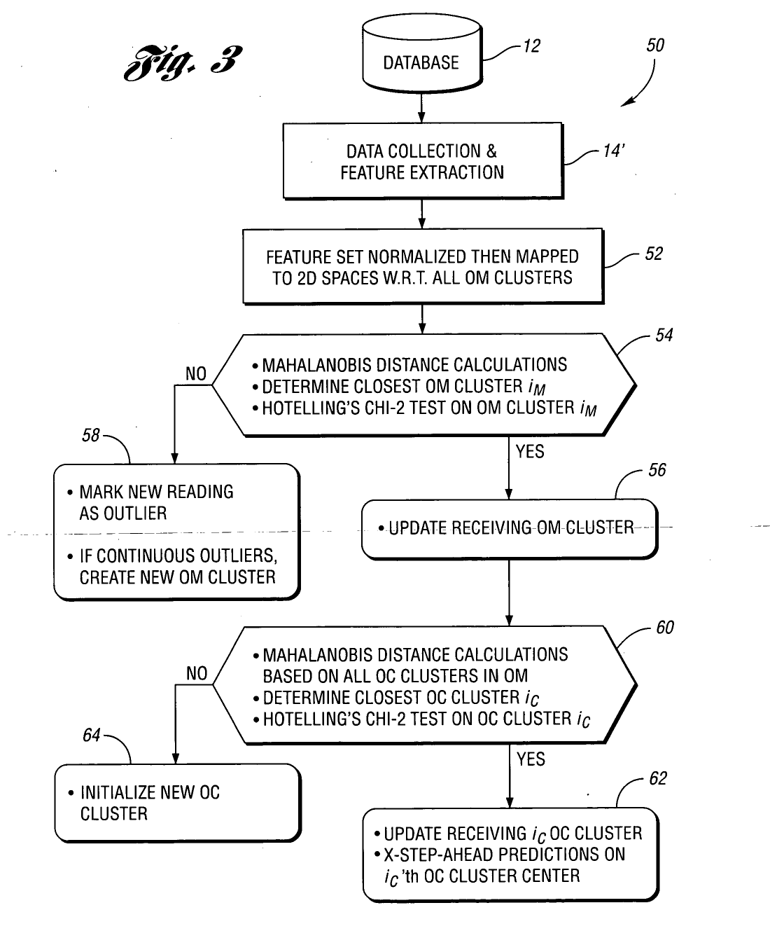

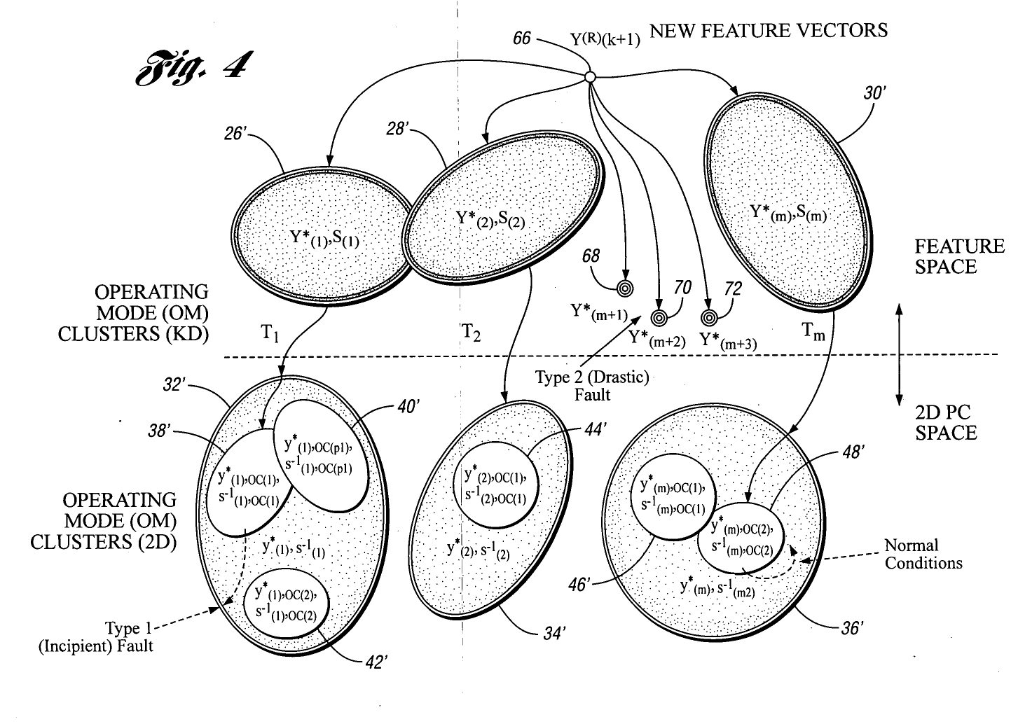

FIGS. 1 and 2 describe and illustrate the initialization phase of the PdM Agent. Similarly, FIGS. 3 and 4 describe and illustrate the monitoring phase of the PdM Agent. FIG. 3 shows a flow chart 50, having the same database 12 as the initialization phase shown in FIG. 1. As new feature data continues to be collected, the PdM Agent enters the monitoring phase where all cluster parameters are recursively updated, and condition based monitoring is performed through continuous evaluation of the position of the feature vector with respect to the OM and OC clusters. Decisions for potential incipient and drastic fault conditions are also automatically generated.

As noted above, the initialization phase is optional, but may be beneficial to provide initial clusters to which new data—as collected in step 14′—can be compared. At step 52 the feature set extracted in step 14′ is normalized and its dimension reduced. This is performed with respect to (w.r.t.) all OM clusters formed in the initialization phase. If the initialization phase is omitted, step 52 in FIG. 3 will still be performed, although there will be no OM clusters yet formed. Thus, the monitoring phase would require the formation of at least one OM cluster, or a cluster could be assumed for purposes of continuing to step 54. Assume, for example, that (m) OM clusters have been identified so far. The new raw feature vector, Y^{(R)}(k+1), is standardized according to expression (1), and mapped to each existing OM clusters using (5). The results are (m) distinct images y₍ⱼ₎(k+1) of Y^{(R)}(k+1) in the different spaces corresponding to the (m) OM clusters.

At step 54, a number of calculations and/or determinations are made. In this step the similarity between the new feature vector and each of the existing operating modes is evaluated. This is done by checking the mahalanobis distances of the new feature vector image to the (m) cluster centers of the 2-D OM clusters:
zⱼ=y₍ⱼ₎(k+1)−y₍ⱼ₎^{*};
Dⱼ(k+1)=zⱼ*s₍ⱼ₎⁻¹*zⱼ, j=[1,m] (7)

Assume, for example, that iₘ is the closet OM cluster, i.e.:
i_{M}=arg minⱼ(Dⱼ(k+1)) (8)

The significance of the similarity between the image vector y₍ᵢ_{_{M}}₎(k+1) and the cluster is further validated by checking the condition:
D(k+1)<11.829 (9)
Condition (9) is derived from the T² Hotelling's statistics:
Tᵢ_{ₘ}²(k+1)<χ_{p,α}² (10)
where
zᵢ_{ₘ}=y₍ᵢ_{_{M}}₎(k+1)−y₍ᵢ_{_{M}}₎^{*};
Tᵢ_{_{M}}²(k+1)=(zᵢ_{_{M}})S₍ᵢ_{_{M}}₎⁻¹(zᵢ_{_{M}}) (11)
χ²_{p,α} is the (1−α)th value of the Chi-squared distribution with p degrees of freedom, and α is the probability of a false alarm, e.g. χ²_{2, 0.0027}=11.8290, χ²_{3, 0.0027}=14.1563, while χ²_{1, 0.0027}=9 corresponds to the well-known+/−3σ limit rule for the case of a single output.

There are two potential outcomes of the condition described by equation (9), which will then lead to either step 56 or step 58. If equation (9) is satisfied, then the new reading Y^{(R)}(k+1) is assumed to follow the distribution that is associated with the i_{M}'th OM cluster with very high possibility. In this case, the process advances to step 56. If equation (9) is not satisfied, then the it is assumed that the closest existing operating mode does not share significant similarities with the current reading. Therefore, the algorithm advances to step 58, where the current reading is temporarily marked as an outlier, and the possibility to create a new operating mode cluster is considered.

If the algorithm advances to step 56, the appropriate OM cluster is updated. At step 56, the i_{M}'th OM cluster is identified as the current operating mode based on the similarity between the associated with i_{M}'th OM cluster and the feature vector y^{(R)}(k+1). Therefore, the parameters of the i_{M}'th OM cluster are updated recursively using the standardized feature vector Y₍ᵢ_{_{M}}₎(k+1) and its 2D image y₍ᵢ_{_{M}}₎(k+1)
Y₍ᵢ_{_{M}}_{).New}^{*}=α₁Y₍ᵢ_{_{M}}₎^{*}+(1−α₁)(Y^{R}(k+1) (13)
S₍ᵢ_{_{M}}_{).New}=α₁S₍ᵢ_{_{M}}₎+(1−α₁)(Y₍ᵢ_{_{M}}₎(k+1)Y₍ᵢ_{_{M}}₎(k+1)′) (14)
y₍ᵢ_{_{M}}_{).New}^{*}=α₁y₍ᵢ_{_{M}}₎^{*}+(1−α₁)y₍ᵢ_{_{M}}₎(k+1) (15)
The last parameter to be updated is the inverse covariance matrix in 2D space s₍ᵢ_{_{M}}₎⁻¹.

$${s}_{( {i}_{M} ) \cdot Old}^{- 1} = {s}_{( {i}_{M} )}^{- 1} \\ zm = {y}_{{i}_{M}}^{*} - {y}_{( {i}_{M} )} ( k + 1 ) \\ {S}_{( {i}_{M} ) \cdot New}^{- 1} = \frac{1}{{α}_{1}} ( {s}_{( {i}_{M} ) \cdot Old}^{- 1} - \frac{{s}_{( {i}_{M} ) \cdot Old}^{- 1} * {zm}^{′} * zm * {s}_{( {i}_{M} ) \cdot Old}^{- 1}}{{α}_{1} + zm * {s}_{( {i}_{M} ) \cdot Old}^{- 1} * {zm}^{′}} ) \qquad ( 16 )$$

At step 60, the similarity between the 2-D image of the feature vector from the iₘ'th OM cluster y₍ᵢ_{_{M}}₎(k+1) and the means of the (pₜ) OC clusters y_{(j).OC(t)}^{*}, t=[1, pₜ], is checked. Expressions (7)-(9) are applied to determine the closest OC cluster, except now it is y₍ᵢ_{_{M}}₎(k+1) and y_{(j).OC(t)}^{*} and corresponding Mahalanobis distances (d) that are being operated on. Assuming, for example, that i_{C} is the closest OC based on expression (8), and the corresponding Mahalanobis distance d₍ᵢ_{_{C}}₎ is bounded by equation (9), then it is assumed that y₍ᵢ_{_{M}}₎(k+1) follows the distribution of i_{C}'th OC with high possibility. In this case, y₍ᵢ_{_{M}}_{).OC(i}_{_{C}}₎^{*} and s₍ᵢ_{_{M}}_{).OC(i}_{_{C}}₎⁻¹, the mean and inverse covariance matrix that define the i_{C}'th OC, are updated according to expressions (15) and (16). The current and previous values of the OC cluster center y₍ᵢ_{_{M}}_{).OC(i}_{_{C}}₎^{*} are used in the next step to update a real time model of the cluster dynamics in order to predict incipient failures.

If equation (9) is satisfied at step 60, the algorithm advances to step 62, where an autoregressive model of the y₍ᵢ_{_{M}}_{).OC(i}_{_{C}}₎^{*} OC cluster is updated. The purpose of this model is to track of the dynamics of the particular cluster over time and to enable the PdM Agent to predict the probability of the OC cluster moving towards the boundary of its corresponding OM cluster. This type of event constitutes a potential drastic fault. Therefore, the dynamics of the OC clusters are used to predict incipient failures. Cluster center dynamics is captured by the linear equation:
y₍ᵢ_{_{M}}_{).OC(i}_{_{C}}₎^{*}(t)=θ(t)^{T}*φ(t)
θ(t)=[y₍ᵢ_{_{M}}_{).OC(i}_{_{C}}₎^{*}(t−1);y₍ᵢ_{_{M}}_{).OC(i}_{_{C}}₎^{*}(t−2);y₍ᵢ_{_{M}}_{).OC(i}_{_{C)}}^{*}(t−3)] (17)
where yᵢ_{_{C}} is the most recent cluster center from i_{C}'th OC cluster and vector θ consists of the previous values of the i_{C}'th OC center. The Kalman filter algorithm is applied to estimate the mean square solution φ(t) of the dynamic system:
φ(t+1)=φ(t)
y₍ᵢ_{_{M}}_{).OC(i}_{_{C}}₎^{*}(t)=θ(t)^{T}*φ(t)+ζ(t) (18)
where ζ(t) represents Gaussian white noise:

$$φ ( t + 1 ) = φ ( t ) + W ( t + 1 ) θ ( t + 1 ) ( {y}_{C} ( t + 1 ) - {θ}^{T} ( t + 1 ) φ ( t ) ) \\ W ( t + 1 ) = W ( t ) - \frac{W ( t ) θ ( t + 1 ) {θ}^{T} ( t + 1 ) W ( t )}{1 + θ ( t + 1 ) W ( t ) θ ( t + 1 )} \qquad ( 19 )$$

The vector of model parameters φ for each OC cluster is saved inside the PdM Agent for future updates. Multiple-steps-ahead prediction for the recently updated OC cluster centers are performed to assess the probability of the particular OC cluster to move toward the boundary of its enclosing OM cluster—something which corresponds to an incipient failure. In general, the two-dimensional feature vectors are analyzed relative to the two-dimensional feature clusters to provide predictive maintenance information for the machine.

If the predicted trajectory of the y₍ᵢ_{_{M}}_{).OC(i}_{_{C}}₎^{*} OC cluster approaches the boundary of the i_{M}'th OM cluster, it is considered to be an indication that incipient changes may lead to a significantly different state, and subsequently to faulty conditions—i.e., a Type 1 (incipient) fault. This is discussed below in conjunction with FIG. 4. In the case where the distance d(i_{C}) is not bounded by expression (10), a new OC will be created based on y₍ᵢ_{_{M}}₎(k+1) to accommodate the occurrence of a potentially new OC cluster.

Returning to step 60 in FIG. 3, if equation (9) is not satisfied, the algorithm advances to step 64, where a new OC cluster is initialized. If equation (9) is not satisfied, it implies that the standardized feature vector Y(j+1) does not belong to any of the existing OM clusters, and is temporarily marked as an outlier. When consecutive incoming new readings fall in this category, it is an indication that a new OM is emerging and these readings will be used to initialize a new OM cluster according to expressions (1)-(6). The consecutive occurrence of new OM clusters indicates that the dynamic of the monitoring process has changed dramatically and rapidly. Thus, it is considered a Type 2 (drastic) fault.

The steps described in FIG. 3 are schematically illustrated in FIG. 4. At the top of the diagram, newly gathered feature vectors 66 are standardized and compared to existing OM clusters 26′, 28′, 30′ in the feature space. As discussed above, some of the new feature vectors 66 may not belong to any of the existing OM clusters 26′, 28′, 30′, in which case, they are marked as outliers 68, 70, 72. Where the occurrence of new OM clusters occurs consecutively, such as with the outliers 68, 70, 72, it is considered a Type 2 fault, as shown in FIG. 4.

For those new feature vectors that belong to an existing OM cluster, they are mapped to the 2-D space as described above and shown in FIG. 4. Within a given OM cluster, the new feature vector may also be mapped inside an existing OC cluster. This mapping may result in movement of the OC cluster, and depending on the type of movement, may indicate an anomaly or fault in the machine. For example, the mapping of the new feature vectors has resulted in a movement of the OC cluster 38′ toward the boundary of the OM cluster 32′. Upon reaching the boundary, an incipient fault is indicated. Conversely, the mapping of the new feature vectors also resulted in the movement of the OC cluster 48′; however, this movement is confined to the existing boundaries of the OM cluster 36′. Therefore, this movement is considered a normal condition for the machine. The outcome of the PdM Agent algorithm can be communicated to plant floor personnel and other decision makers via graphical displays or other output configurations which simplify the interpretation of the information.

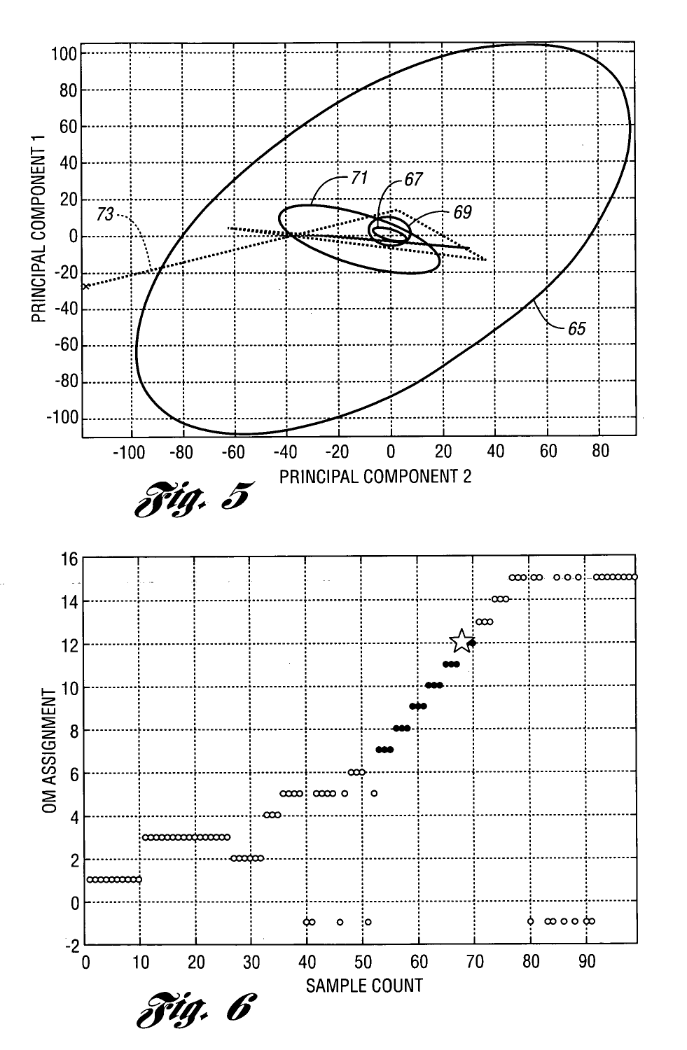

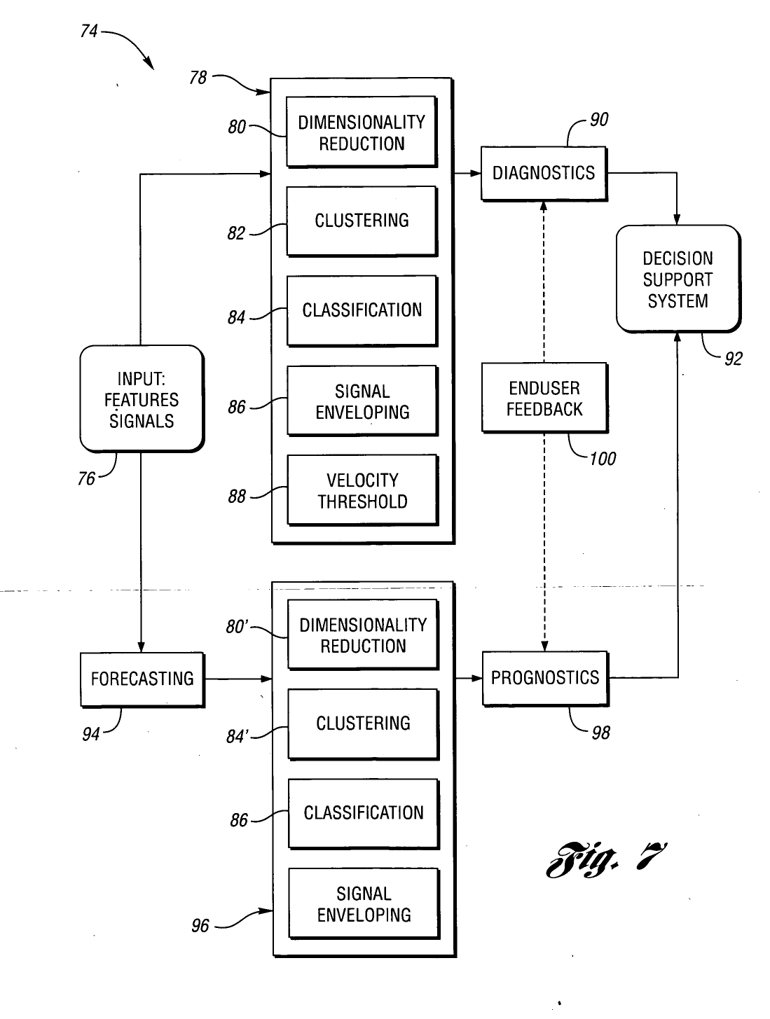

FIGS. 5 and 6 illustrate results of tests performed using the PdM Agent algorithm, and how it provides predictive information regarding impending machine anomalies or failures. For example, FIG. 5 shows an OM cluster 65 generated by applying the PdM Agent algorithm to vibration data gathered from bearings used on an operating machine. Within the OM cluster 65 are three different OC clusters 67, 69, 71. The line 73 illustrates the predicted shift of the center of the OC cluster 71. As shown in FIG. 5, the predicted center moves toward the boundary of the OM cluster 65, and ultimately goes outside of it. The movement toward the boundary of the OM cluster is an indication that a Type 1, incipient, failure is likely to occur. This prediction occurs well in advance of an actual failure, thereby facilitating preventative maintenance prior to actual component failure.

Similarly, FIG. 6 shows data points generated from application of the PdM Agent algorithm to vibration data. Along the ordinate of the graph (OM Assignment), are the numbers associated with various OM clusters. Most of the data points lie in relatively long horizontal lines, indicating that they fit within one of the OM clusters generated from the data. Some of the data points form a much shorter line, however, and this indicates that these points do not belong to any OM cluster see, e.g., OM Assignments 7-12. Like the points 68, 70, 72 shown in FIG. 4, the points in these OM Assignments are outliers, and are indicative of a pending Type 2 (drastic) fault. In fact, the PdM Agent predicts a drastic fault along the line where OM Assignment 12 would be. Again, this prediction occurs in advance of any real failure, thereby allowing for preventive correction of the problem.

FIG. 7 illustrates another embodiment of a method in accordance with the present invention. In particular, FIG. 7 shows a flow chart 74 illustrating the basic elements of a Diagnostics and Prognostics Framework (DPF), which, like the PdM Agent described above, can be used for predictive maintenance of a machine. As with the PdM Agent, the inputs to the DPF are features or raw signals—see block 76. In a broad sense, the DPF takes two paths: a diagnostics path and a prognostics path. The diagnostics path is driven by a diagnostics engine 78, which includes a number of processes.

To avoid confusion with the PdM Agent described above, the DPF will be described using slightly different notation for the vectors, means, and covariance matrices. DPF employs a clustering method in the two-dimensional principal component space to detect and characterize potentially distinct equipment modes of operation. It can, for example, support Kernel Density Estimation based clustering, as well as Gaussian Mixture Model based clustering. Once clustering is performed, each cluster (i) is characterized using a mean vector (μᵢ) and a covariance matrix (Σᵢ), forming a two tuple (μᵢΣᵢ).

Just as with the PdM Agent, the DPF takes the raw data or features and performs a dimensional reduction from a feature space to a 2-D space—see step 80. In addition, step 82, may also be performed as in the PdM Agent. In general, the diagnostics path uses three methods of analysis: (a) diagnostics based on classification (called [symbol] ^{C}), which is a multivariate, multi-basis classification system, (b) diagnostics based on feature/signal enveloping (called [symbol] ^{SPC}) , which is a univariate enveloping system, and (c) diagnostics based on velocity threshold (called [symbol] ^{V}) These three domains contribute to the overall diagnostics result. The diagnosis result is a number called ‘severity rating’, S_{R}, computed through a voting algorithm as follows:
Let, r_{c} denote the contribution of [symbol] ^{C} to S_{R} (0≦r_{c}≦1), r_{spc} denote the contribution of [symbol] ^{SPC} to S_{R} (0≦r_{spc}≦1), and rᵥ denote the contribution of [symbol] ^{V} to S_{R} (0≦rᵥ≦1), then S_{R} is computed as follows:
   S_{R}=w_{c}r_{c}+w_{spc}r_{spc}+wᵥrᵥ, 0≦S_{R}≦1
   where, wᵢ (0≦wᵢ≦1) are the weights assigned to each of the three diagnostics decision making domains. In the absence of any knowledge for which domain might provide better diagnostics, all wᵢ^{s} can be set equal; in this context to one third (⅓). These three methods of analysis are shown in FIG. 7, and are represented in blocks 84, 86, 88, respectively.

Turning to the diagnostics based on classification, shown in block 84, the DPF assigns a new feature vector to existing clusters based on the smallest Generalized Statistical Distance (also called Mahalanobis Distance): D=(X_{new}−\hat{μ}ⱼ)^{T}\hat{Σ}ⱼ⁻¹(X_{new}−\hat{μ}ⱼ). Classification is done after dimension reduction, in two-dimensional PC space. The DPF employs an exponential weighted moving average method for recursive estimation of mean and covariance matrices. For feature (j), using the new observation (xⱼ), the recursive estimation expressions are (used for constructing a feature envelope):
\hat{μ}_{j(new)}=α\hat{μ}_{j(old)}+(1−α)x_{j(new)} (20)
\hat{σ}_{j(new)}=α\hat{σ}²_{j(old)}+(1−α)(x_{j(new)}−\hat{μ}_{j(old)})^{T}(x_{j(new)}−\hat{μ}_{j(old)}) (21)
For the complete feature vector (X), the recursive estimation expressions are (used for updating PC Basis):
\hat{μ}_{(new)}=α\hat{μ}_{(old)}+(1−α)X_{(new)} (22)
\hat{Σ}_{(new)}=α\hat{Σ}_{(old)}+(1−α)(X_{(new)}−\hat{μ}_{(old)})^{T}(X_{(new)}−\hat{μ}_{(old)}) (23)

Like the PdM Agent, the diagnostics based on classification determines whether a given feature vector or data point lies within an existing cluster, Cᵢ, or whether it is an outlier. One criterion for labeling a point an ‘outlier’is: (X_{new}−\hat{μ}ⱼ)^{T}\hat{Σ}ⱼ⁻¹(X_{new}−\hat{μ}ⱼ)≧χ_{d}²(β)∀j. This implies that if (X_{new}) is not within the β% (for example, ≧99%) probability contour of N(μⱼ,Σⱼ), but still is closest to cluster (j) than any other cluster in terms of the generalized statistical distance, the data point gets labeled an outlier to cluster (j).

Three different cases are considered here for diagnostics:
(i) Point X_{new} belongs to cluster Cᵢ: if this criterion is satisfied, the point is considered inside normal behavior limits, and the diagnosis result is considered normal (r_{c}=0);
(ii) Point X_{new} is an outlier to Cᵢ: under this case, the point is outside the normal behavior limits, and hence, it is likely that the equipment behavior is abnormal (r_{c}=0.5); and
(iii) ‘m’ consecutive points are outliers: this case implies that the system is abnormal with a high probability, and hence, the highest severity value in [symbol] ^{C} is assigned (r_{c}=1). Typically, m=3 is chosen.

The signal enveloping, shown at block 86, is a limit-based system, and uses diagnosis based on univariate signal envelopes. For each of the features/signals, signal envelopes are constructed recursively using a ±kσ limit, where (k) is a predetermined value based on the size of the envelope desired. The actual expressions are based on equations (20)-(23), shown above. A new feature point (xⱼ) is considered an outlier if |xⱼ−\hat{μ}ₓ_{ⱼ}|≧k\hat{σ}ₓ_{ⱼ}. If among the (n) features, (n₁) features fall beyond the ±kσ limits, then the severity value is set at r_{spc}=n₁/n.

In addition to the classification and signal enveloping, the diagnostics path also includes a determination of velocity thresholds. Standardized velocity within individual clusters is estimated based on consecutive feature vector entries as follows. If (X₁) and (X₂) denote the most recent consecutive feature vectors in (Rⁿ), collected at time instants (t₁) and (t₂), then the standardized velocity is calculated as follows:

$${V}_{{t}_{2}} = \frac{\sqrt{{( {Z}_{2} - {Z}_{1} )}^{T} ( {Z}_{2} - {Z}_{1} )}}{n ( {t}_{2} - {t}_{1} )} ,$$

where, Z is standardized feature vector obtained by standardizing each element of X using the formula:

$${z}_{j} = \frac{{x}_{j} - {μ}_{j}}{{σ}_{j}} , ∀ j .$$

For purposes of using the velocity thresholds in the diagnostics portion of the DPF, rᵥ is assigned value of 1 if V>Vₜₕ, or else rᵥ is set to 0. Typically Vₜₕ is set to 5.

The output 90 from the diagnostics engine 78 is in communication with a decision support system (DSS) 92. The DSS 92 uses diagnostics/prognostics results and recommends necessary actions for maintenance. A DSS, such as the DSS 92, may include computers with preprogrammed algorithms configured to return certain outputs based on the information received from the DPF. As with the PdM Agent, the outputs based on the DPF information may be in the form of graphical displays or other methods useful to shop floor and other decision making personnel.

As illustrated in FIG. 7, a prognostics engine 96 employs algorithms similar to the diagnostics engine 78, with like processes being labeled with the prime (′) symbol. One difference with the prognostics engine is that the inputs are based on forecast signals—see block 94. In the DPF, the prognostics module calculates a severity rating like the diagnostics module would. This severity rating is only based on the classification and feature enveloping methods, however, and does not include the velocity threshold method.

With regard to the forecasting signals, each feature/signal is considered as a time series (xₜ). A univariate time series forecasting method is employed to predict values of xₜ₊₁, xₜ₊₂, xₜ₊₂ and xₜ₊₄. In one implementation, an autoregressive time series model of order 7, AR(7), is fitted to (xₜ) and used for forecasting. As with the output 90 from the diagnostics engine 78, output 98 from the prognostics engine 96 is also in communication with the DSS 92.

In addition, both outputs are in communication with an end-user feedback system 100. Given the technical difficulty of developing diagnostic and prognostic algorithms, it is pragmatic to believe that most DPF's will not achieve 100% accuracy in diagnostics or prognostics. Therefore, the current DPF includes the feedback system 100, which is designed to incorporate user feedback for the classification based diagnostics system. The feedback system 100 can allow shop floor personnel, for example, to manually input information into the system to remedy known incorrect decisions. Such a system may be employed with the PdM as well as the DPF, and provides one more method for ensuring the integrity of the information provided.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method for predictive maintenance of a machine, the method comprising:
collecting data related to operation of the machine;
transforming at least some of the data into feature vectors in a first feature space;
standardizing at least some of the feature vectors, thereby creating standardized feature vectors in a standardized feature space;
transforming at least some of the standardized feature vectors into two-dimensional feature vectors in a two-dimensional feature space;
clustering at least some of the two-dimensional feature vectors based on similarity between the two-dimensional feature vectors, thereby forming at least one two-dimensional vector cluster;
collecting additional data related to operation of the machine;
transforming at least some of the additional data into additional feature vectors in the first feature space;
standardizing at least some of the additional feature vectors, thereby creating additional standardized feature vectors in the standardized feature space;
transforming at least some of the additional standardized feature vectors into additional two-dimensional feature vectors in the two-dimensional feature space; and
analyzing at least some of the additional two-dimensional feature vectors relative to the at least one two-dimensional vector cluster to provide predictive maintenance information for the machine.

2. The method of claim 1, wherein the clustering of at least some of the two-dimensional feature vectors includes forming a cluster based on an operating mode of the machine, and further includes forming, within the operating mode cluster, a cluster based on an operating condition of the machine, the operating condition occurring while the machine is operating in the operating mode.

3. The method of claim 2, wherein analyzing at least some of the additional two-dimensional feature vectors includes updating the operating condition cluster to determine a movement of the operating condition cluster toward a boundary of the operating mode cluster, thereby facilitating a determination of a future anomaly in the operation of the machine.

4. The method of claim 1, further comprising clustering at least some of the standardized feature vectors based on similarity between the standardized feature vectors, thereby forming at least one standardized vector cluster.

5. The method of claim 4, wherein the clustering of at least some of the standardized feature vectors includes forming a cluster based on an operating mode of the machine, the method further comprising analyzing at least some of the additional standardized feature vectors relative to the at least one standardized vector cluster to provide predictive maintenance information for the machine.

6. The method of claim 5, wherein analyzing at least some of the additional standardized feature vectors includes determining whether the additional standardized feature vectors analyzed fit within any of the at least one standardized vector cluster, thereby facilitating a determination as to whether a new operating mode cluster should be formed.

7. The method of claim 1, wherein the at least some of the feature vectors are standardized using vectors for a statistical mean for the collected data and vectors for a statistical standard deviation for the collected data, and
wherein transforming at least some of the standardized feature vectors into corresponding two-dimensional feature vectors includes extracting the first two principal components of each of the at least some standardized feature vectors to define a map from the standardized feature space to the two-dimensional feature space.

8. The method of claim 1, wherein analyzing at least some of the additional standardized feature vectors includes applying at least one of a classification-based system or a limit-based system.

9. The method of claim 8, wherein the classification-based system includes determining whether each of the additional two-dimensional feature vectors lies within any of the at least one two-dimensional vector clusters, and the limit-based system includes setting upper and lower limits and determining whether each of the additional two-dimensional feature vectors lies within the upper and lower limits.

10. The method of claim 9, wherein analyzing at least some of the additional standardized feature vectors includes applying the classification-based system, the limit-based system, and a velocity-based system, the velocity-based system including a determination of a corresponding velocity for each of the additional two-dimensional feature vectors and a comparison of each of the corresponding velocities to a predetermined velocity, and wherein application of each of the systems produces a corresponding diagnostic result which is assigned a weight value.

11. A method for predictive maintenance of a machine, the method comprising:
collecting feature data for the machine while the machine is operating, the feature data including a plurality of feature vectors;
standardizing at least some of the feature vectors to facilitate compatibility between the standardized feature vectors;
transforming at least some of the standardized feature vectors into corresponding two-dimensional feature vectors;
clustering at least some of the two-dimensional feature vectors based on the operating modes of the machine, thereby forming a plurality of two-dimensional operating mode clusters;
collecting additional feature data while the machine is operating, the additional feature data including a plurality of additional feature vectors:
standardizing at least some of the additional feature vectors;
transforming at least some of the additional standardized feature vectors into corresponding additional two-dimensional feature vectors; and
applying an algorithm to at least some of the additional two-dimensional feature vectors to facilitate a comparison between the operation of the machine when the feature data was collected and operation of the machine when the additional feature data was collected, thereby providing predictive maintenance information for the machine.

12. The method of claim 11, further comprising:
calculating a statistical mean for the feature data; and
calculating a statistical standard deviation for the feature data, thereby respectively creating vectors for the mean and standard deviation of the feature data, and
wherein standardizing at least some of the feature vectors includes applying the vectors for the mean and standard deviation of the feature data to the feature vectors to create the standardized feature vectors, and transforming at least some of the standardized feature vectors into corresponding two-dimensional feature vectors includes the use of a rotational transform which multiplies the at least some standardized feature vectors by a basis matrix, thereby computing principal components of the at least some standardized feature vectors.

13. The method of claim 11, wherein applying an algorithm to at least some of the additional standardized feature vectors includes applying at least one of a classification-based algorithm or a limit-based algorithm.

14. The method of claim 13, wherein the classification-based algorithm includes determining whether each of the additional two-dimensional feature vectors lies within any of the at least one two-dimensional vector clusters, and the limit-based algorithm includes setting upper and lower limits and determining whether each of the additional two-dimensional feature vectors lies within the upper and lower limits.

15. The method of claim 14, wherein applying an algorithm to at least some of the additional standardized feature vectors includes applying the classification-based algorithm, the limit-based algorithm, and a velocity-based algorithm, the velocity-based algorithm including a determination of a corresponding velocity for each of the additional two-dimensional feature vectors and a comparison each of the corresponding velocities to a predetermined velocity, and
wherein application of each of the systems produces a corresponding diagnostic result which is assigned a weight value.

16. The method of claim 11, wherein the clustering of at least some of the two-dimensional feature vectors includes forming a cluster based on an operating mode of the machine, and further includes forming, within the operating mode cluster, a cluster based on an operating condition of the machine, the operating condition occurring while the machine is operating in the operating mode.

17. The method of claim 16, wherein applying an algorithm to at least some of the additional two-dimensional feature vectors includes updating the operating condition cluster to determine a movement of the operating condition cluster toward a boundary of the operating mode cluster, thereby facilitating a determination of a future anomaly in the operation of the machine.

18. The method of claim 11, further comprising clustering at least some of the standardized feature vectors based on similarity between the standardized feature vectors, thereby forming at least one standardized vector cluster.

19. The method of claim 18, wherein the clustering of at least some of the standardized feature vectors includes forming a cluster based on an operating mode of the machine, the method further comprising analyzing at least some of the additional standardized feature vectors relative to the at least one standardized vector cluster to provide predictive maintenance information for the machine.

20. The method of claim 19, wherein analyzing at least some of the additional standardized feature vectors includes determining whether the additional standardized feature vectors analyzed fit within any of the at least one standardized vector cluster, thereby facilitating a determination as to whether a new operating mode cluster should be formed.

21. A method for predictive maintenance of a machine, the method comprising:
collecting feature data for the machine;
defining feature vectors from the feature data;
standardizing the feature vectors;
clustering the standardized feature vectors based on operating modes of the machine;
transforming the standardized feature vectors into corresponding two-dimensional feature vectors;
clustering the two-dimensional feature vectors at least based on the operating modes of the machine; and
recursively analyzing new feature data relative to at least some of the clusters, thereby providing predictive maintenance information for the machine.

22. The method of claim 21, wherein clustering the two-dimensional feature vectors includes a first clustering based on the operating modes of the machine, and a second clustering based on operating conditions of the machine, the operating conditions occurring within the operating modes.

23. The method of claim 21, wherein recursively analyzing new feature data includes using the new feature data to track movement of the operating condition clusters, thereby providing information related to a first type of machine anomaly.

24. The method of claim 21, wherein recursively analyzing new feature data includes using the new feature data to determine if new operating mode clusters should be formed, thereby providing information related to a second type of machine anomaly.

25. The method of claim 21, further comprising calculating standardized velocity for the standardized feature vectors, and wherein recursively analyzing new feature data includes applying at least one of: a classification-based analysis, a limit-based analysis, or a velocity-based analysis.

26. The method of claim 25, wherein recursively analyzing new feature data includes applying the classification-based analysis, the limit-based analysis, and the velocity-based analysis, each of which produces a corresponding diagnostic result which is assigned a weight value.
